(19) United States
(12) Patent Application Publication
(10) Pub. No.: US 2009/0189381 A1
(43) Pub. Date: Jul. 30, 2009

(54) Universal quick detach multi-position accessory mount for vehicles or the like

(75) Inventor: Ralph P. Kirtland, Staunton, VA (US)

Correspondence Address: EDWARDS ANGELL PALMER & DODGE LLP, P.O. BOX 55874, BOSTON, MA, 02205, US

(73) Assignee: Archimedes Intellectual, LLC, Staunton, VA (US)

(21) Appl. No.: 12/385,188

(22) Filed: Apr. 1, 2009

Related U.S. Application Data
(63) Continuation-in-part of application No. 11/592,159, filed on Nov. 3, 2006.

(51) Int. Cl. B60R 9/00

(52) U.S. Cl. 280/769; 224/511; 224/547; 224/555

(57) ABSTRACT

An accessory mounting system for vehicles or the like including one or more mounting rails, one or more mounting clamps, one optional sliding rail per clamp, and one optional hinged latching mechanism per clamp. The mounting rail is trapezoidal in profile, and may include one or more pieces, and is permanently mounted to the vehicle frame, body, or other component and oriented with the wider of the two parallel faces facing outward from the vehicle's mounting surface. The mounting clamp assembly utilizes two opposed V-shaped jaws of an equal or slightly more acute angle than that represented by the angle between the wider of the two parallel faces of the mounting rail and one of its two adjoining non-parallel faces such that when the mounting clamp assembly is engaged on the mounting rail, an interference fit occurs causing the mounting rail to nest between the two opposing jaws of the mounting clamp assembly, creating maximum surface area contact between the mounting clamp and the mounting rail in order to generate a very high coefficient of friction.

### BACKGROUND OF THE INVENTION

1. Field of the Invention

This invention relates to an apparatus and processes for removably attaching an accessory mounting adapter to a main structure. More particularly, the present invention relates to a mounting arrangement for retaining an accessory adapter on a vehicle so that the adapter is capable of accepting substantial loads when attached. The present invention is particularly useful as a universal accessory attachment for motor vehicles such as trucks, automobiles, vans, campers and the like, as well as aircraft such as helicopters and watercraft, wherein the adapter for attaching the accessories can be easily removed, thereby leaving the mounting framework so as not to interfere with the normal functions of the vehicle structure.

2. Description of the Related Art

Various devices have been developed in the past for the purpose of permitting temporary attachment of accessories to motor vehicles and the like. Link and pin arrangements have been used where the attachment is for a separately wheeled vehicle, such as for obsolete railway car connections, farm vehicles and the like. Such loose attachment configurations are not suitable for supporting the weight of the accessory and, thus, there have been some efforts to develop improvements along these lines. For instance, U.S. Pat. No. 2,867,402 to Graybill et al. shows an arrangement for attaching a framework to the bumper of a motor vehicle. Such attachments are useful for relatively light loading purposes but the general structural weakness of vehicle bumpers frequently precludes their use for supporting substantial loads. Accordingly, other devices have been developed for the purpose of transferring loads to the substantial vehicle frame members, such as the outboard motor carrier shown in U.S. Pat. No. 2,592,050 to McCharen. Various other arrangements have been developed for attaching accessories to vehicle frames, particularly for trailer hitches and the like. Such devices require relatively permanent attachment to the vehicle frame and cannot be easily removed when not needed.

Accordingly, there have been further efforts to provide a removable carrier attachment for motor vehicles. For instance, U.S. Pat. No. 3,039,634 to Hobson et al. suggests an arrangement for clamping tubular members to the underframe of an automobile and pinning an outboard motor carrier to the tubular members when needed. Yet another arrangement suggested for attaching a carrier for a motorbike or the like to a vehicle frame is shown by U.S. Pat. No. 3,796,333 to Goldstein, whereby the trailer hitch of an existing mount is replaced by a pivotal bicycle or motorbike carrier structure.

The ubiquitous receiver hitch is currently the most popular method for temporarily attaching accessories to a vehicle. It is evidence of the ever-increasing need for an adapter attachment for a motor vehicle which can be easily changed so as to accommodate one or more of various accessories or accessory functions but can be removed in a manner so as to not impair the normal functions of the vehicle body. The receiver hitch evolved from a system designed to easily accommodate the interchange of different towing connectors into one also used for accessory attachment. In its most common form, it incorporates a square steel bar attached to an accessory that is inserted into a like-sized square steel socket attached to the vehicle. Receiver hitches, while extremely popular, suffer from three significant shortcomings: a) the number and position of accessories which can be attached: b) the load carrying capacity of the receiver bar; and c) rattling caused by the loose slip-fit of the bar into the receiver.

U.S. Pat. No. 4,204,702 to Oltrogge is directed toward eliminating any accessory rattling by use of a clamp, albeit one secured through the use of tabs on the mounting bar. This device fails to improve upon the receiver hitch's limitation on the number and position of accessories attached because it specifically addresses a single accessory attachment via welded tabs and slots at a single point on the vehicle, thereby limiting one's ability to fully benefit from today's rich and abundant vehicle accessory market. Today there are many smaller accessories available that may be mounted in multiples to many different areas of a vehicle, such as externally mounted spare tires, gas cans, fire extinguishers, heavy duty jacks, and winches, which may be mounted to the front, rear, and sides of a vehicle.

It should be noted that vehicle bumpers are now large, multi-contoured constructions often fully integrated with the bodywork of the vehicle. Sufficient clearances between bumpers and bodywork rarely exist in the modern world to permit passing the jaws of an accessory adapter clamp over the bumper in order to engage a hidden mounting bar. Therefore, if a clamp jaw utilizing Oltrogge's method was sufficiently reduced in thickness to pass between the bumper and the bodywork, it would afford insufficient structural rigidity and support. Oltrogge is also limited to only two accessories for concurrent mounting, where one is mounted above the other in predetermined mounting locations.

The mounting arrangement for the accessory adapter disclosed herein provides improved flexibility in that the mounting rail can be attached to the vehicle frame or body—with load capacity commiserate with mounting location—as well as its ability to accommodate an almost unlimited variety of multiple accessories concurrently mounted to one mounting rail, with accessories positioned horizontally and vertically in an almost infinite variety of positions in relation to the mounting rail, enabling the most efficient use of the space afforded by the mounting rail. Furthermore, the mounting rail can double as the vehicle's bumper for front and rear mounting applications, and in many cases a decorative cover or the factory supplied bumper could be reattached as an accessory, if desired.

### SUMMARY OF THE INVENTION

This invention is an apparatus and process for securely and removably attaching any of a wide variety of accessories to a main structural member such as a vehicle, aircraft, watercraft, building structure or the like. The invention finds utility in securely but removably attaching vehicle accessories to a motor vehicle in a manner which permits multiple accessories to be mounted in close proximity to each other at many different locations on the vehicle as well as accommodating substantial loading for those locations incorporating attachment to the chassis of the vehicle. A mounting rail is first secured to the vehicle, and accessories are then removably attached through the use of one or more mounting clamps per accessory with or without one optional slider rail per mounting clamp.

The mounting rail is trapezoidal in profile; may include of one or more pieces; and is permanently mounted to the vehicle frame, body, or other component and oriented with the wider of the two parallel faces facing outward from the vehicle. The mounting clamp utilizes two opposed V-shaped jaws of an equal or slightly more acute angle than that represented by the angle between the wider of the two parallel faces of the mounting rail and one of its two adjoining non-parallel faces such that when the mounting clamp is engaged on the mounting rail, an interference fit occurs causing the mounting rail to nest between the two opposing jaws of the mounting clamp, creating maximum surface area contact between the mounting clamp and the mounting rail in order to generate a very high coefficient of friction.

The mounting clamp may further be combined with a slider rail, I-shaped in profile, including two opposite, parallel, flat faces, one of which is flanged in order to engage with gripping plates attached to the clamping mechanism, and the other of which is flanged to engage with gripping plates attached to the accessory. The gripping plates are L-shaped and positioned parallel to the slider rails and overlap the flanges so as to create a high coefficient of friction when tightly fastened to either the mounting clamps or the accessory.

The mounting clamp may further be combined with a hinged latching mechanism to enable the loading of heavier accessories. The hinged mechanism would be opened to facilitate the engagement of the mounting clamp onto the mounting rail by tilting the accessory, eliminating the need to support the full weight of the accessory during the engagement process. This hinged mechanism would be self-latching so that once the mounting clamp is engaged on the mounting rail, the accessory can be tilted up into a raised, horizontal position held elevated above the ground once the hinged mechanism latches closed.

Although the method for generating the clamping force in the mounting clamp can vary, the two embodiments presented herein involve alternate yet equally desirable methods for achieving that force. A common feature of both embodiments is the movement of the lower jaw in relationship to the upper jaw in order to create an interference fit between the V-shaped portions of both jaws and their respective mating surfaces on the mounting rail in order to generate a high coefficient of friction to prevent movement of an accessory once attached.

The first embodiment utilizes a rotatable cam sandwiched between the upper, stationary jaw and the lower, movable jaw. When rotated to engage the mounting clamp on the mounting rail, the cam pushes against a push-block, inserted below it into the upper jaw housing, and against a raised lip of the lower jaw positioned above it. As the space between the push-block of the upper jaw and the raised lip of the lower jaw increases, the distance between the V-shaped portions of the respective jaws decreases, thereby creating the clamping force. At top dead center of the cam's rotation—at its tallest point—one or both of the cam rollers that engage the two pushing surfaces nest in indentations in the center of one or both of the pushing surfaces, thereby limiting the cam's rotation. The spring action afforded by both the push block and the V-shape of the jaws (each jaw having a slightly more acute angle than the corresponding mating surfaces of the mounting rail) work to hold the cam in the locked position. Matching holes are provided on overlapping areas of the upper and lower jaws that will align when the mounting clamp is fully engaged on the mounting rail, allowing a padlock, bolt or retention pin to further restrict the unlocking of the mounting clamp if a user so chooses. Rotation of the cam is achieved through the use of a removable handle that, when inserted into the cam, allows rotation of the cam in either direction. Because the cam is rotatable through 360 degrees of travel, 90 degrees of rotation in either direction will transition the cam from an engaged state to a released state or back again.

Because of the compression resulting from the interference fit of the mounting clamp jaws onto the mounting rail, it is often necessary to jar the lower jaw loose even after rotating the cam into the release position. Handle stowage can be integrated into the clamp body itself either internally or through the use of a channel in the accessory mounting face of the mounting clamp. With the accessory bolted to the mounting clamp, this channel provides a slot into which the handle can be inserted for stowage. This handle stowage slot used in combination with a striking surface attached to the lower jaw, allows the action of handle storage to also jar the lower jaw loose.

A second embodiment of the mounting clamp encompasses subcomponents that interact in such a way as to convert the energy used in setting a clamp-enabled accessory onto the mounting rail into a highly leveraged action which draws the upper and lower jaws together, creating the interference-fit clamping-force similar to that described above. Rather than the rotation of a cam drawing the two jaws together as described in the first embodiment, the movement of the accessory from a tilted position (typically done to engage the mounting clamp upper jaw on top edge of mounting rail) into a horizontal position (the final resting position) draws the lower jaw closer to the upper jaw. The use of a retention pin through aligned holes in the upper jaw, lower jaw, and clamp actuator/accessory mount subcomponents would secure the mounting clamp in position on the mounting rail.

The two clamp embodiments appeal to separate and distinct applications. The first embodiment would be preferable for tall accessories where the room to tilt the accessory toward the mounting rail is limited, as well as preferable for true off-road and other high-vibration uses due to there being zero slip from accessory to clamp to rail to vehicle. The second embodiment would be preferable for casual users and applications that require more frequent repositioning of accessories, as well as in applications where the use of the cam-rotation bar is problematic.

Although the method for assembling the mounting rails and attaching them to the vehicle can vary, the functional aspect of the mounting rail is its trapezoidal profile and its size in relation to the mounting clamp. A method for assembling and attaching a mounting rail to a vehicle as described herein involves loosely bolting the U-shaped mounting rail base plate to the vehicle using flange expander plates, sandwiching the mounting rail base plate between the flange expander plates and the vehicle mounting surface. The mounting rail cover, the outside surface of which becomes the clamp mounting surface after final assembly, is then slid over the mounting rail base plate until flush at each end. At this point, the bolts that go through the flange expander plate and the mounting rail base plate are tightened, drawing the flange expander to nest into the base plate, thereby expanding the base plate into the cover and locking the cover in place.

The mounting rails, when used on the front or rear surfaces of a motor vehicle, and when constructed of sufficiently dense material, can adequately substitute as the vehicle's bumpers, in many cases exceeding the impact capacity of the original equipment bumpers. The original equipment bumpers can, in many cases, be equipped with mounting clamps and reattached to the mounting rails as an accessory. Mounting rails can also be equipped with non-functional coverings to improve the aesthetic appeal, such as hinged or slotted, step-bumper-like tops, molded end caps.

### BRIEF DESCRIPTION OF THE DRAWINGS

FIG. 1 is an isometric, exploded view of the mounting clamp accessory adapter of the present invention.

FIGS. 2A and 2B are isometric views of the mounting clamp accessory adapter of the present invention with clamp assembly closed and open, respectively.

FIG. 3 is an isometric view of the mounting clamp accessory adapter of the present invention mounted on a mounting rail.

FIG. 4 is an isometric view of the mounting rail base plate component of the present invention with two-hole flange expander adjacent to vehicle frame rail.

FIGS. 5A and 5B are frontal transparent views of the clamping mechanism of the present invention with clamp assembly closed and open, respectively.

FIG. 6 is same view as FIGS. 5A and 5B but with a removable cam-rotation bar inserted.

FIGS. 7A-7D are isometric views of a four-step mounting rail assembly process for the present invention.

FIGS. 8 and 9 are isometric views of the slider rails in use with the mounting clamp of the present invention.

FIG. 10 is a reverse-angle isometric view of the present invention in use with two concurrent accessories.

FIG. 11 is a low-angle isometric view of the present invention in use with a single, large accessory.

FIGS. 12A and 12B show isometric and profile views, respectively, of a solid mounting rail with a mounting clamp assembly mounted thereon.

FIGS. 13A and 13B show isometric and profile views, respectively, of another solid mounting rail with a mounting clamp assembly mounted thereon.

FIGS. 14A and 14B show isometric and profile views, respectively, of one embodiment of a stamped mounting rail with a mounting clamp assembly mounted thereon.

FIGS. 15A and 15B are isometric views of another embodiment of a single stamped mounting rail and a plurality of nested stamped mounting rails, respectively.

FIG. 15C show a profile view of a plurality of nested stamped mounting rails.

FIGS. 16A and 16B show isometric and profile views, respectively, of still another embodiment of a stamped mounting rail with a mounting clamp assembly attached thereto.

FIGS. 17A-17C show isometric and profile views of an “extruded” solid mounting rail with a plurality of mounting clamp assemblies attached thereto, where FIG. 17A is a close-up view of FIG. 17B and FIG. 17C is a profile view of the mounting rail.

FIGS. 18A and 18B are front and back views, respectively, of a mounting clamp cover fastened with standard bolts.

FIGS. 19A and 19B are front and back views, respectively, of a mounting clamp cover fastened with countersunk bolts.

FIGS. 20A-20G are isometric views of progressive stages in the construction of the mounting clamp assembly.

FIGS. 21A-21D are isometric views of cam-rotation bar stowage and lower jaw release method.

FIGS. 22A-22E are isometric views of the second embodiment of a mounting clamp transitioning from fully open to fully closed and locked.

FIGS. 23A-23D are side phantom views of the second embodiment of a mounting clamp transitioning from fully open to fully closed.

FIG. 24A is a side phantom view of the hinged latching mechanism assembly.

FIGS. 24B-24E are isometric views of the hinged latching mechanism assembly in various states.

FIGS. 25A-25C are isometric views of a wheeled accessory being outfitted with a hinged latching device and mounting clamp.

FIGS. 26A and 26B are isometric views showing a wheeled accessory before and after mounting to sport utility type of vehicle.

FIGS. 27A-27G are solid side views of the steps needed to mount a wheeled accessory equipped with a mounting clamp and a hinged latching mechanism to a mounting rail equipped sport utility type of vehicle.

### DETAILED DESCRIPTION OF EXEMPLARY EMBODIMENTS

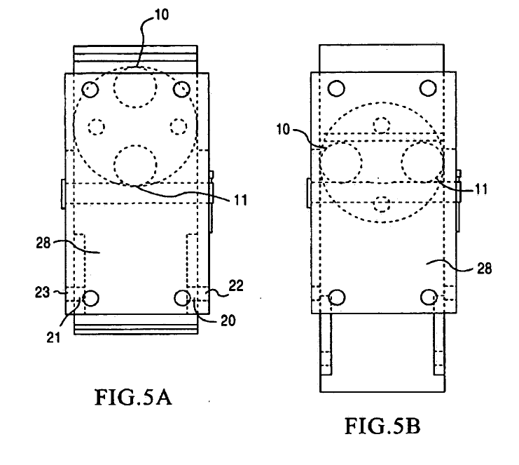

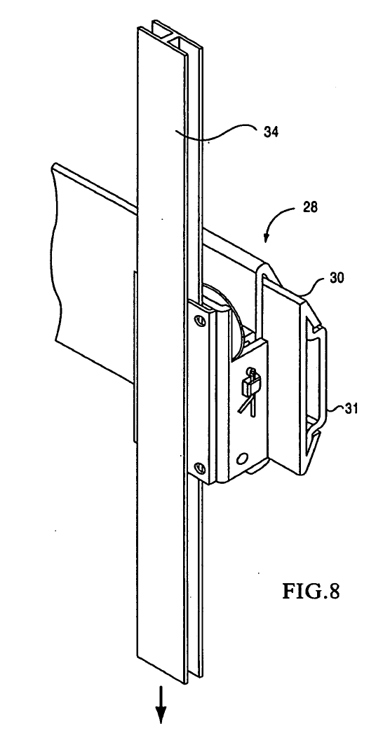

An exemplary utility for the present invention is envisioned in conjunction with motor vehicles and thus exemplary embodiments will be described in association with a sport utility type of vehicle 41. Such vehicles typically include a major underframe for load bearing purposes as illustrated by beams 42 and 43 in FIGS. 4 and 7A. The same method that is illustrated here for attaching the mounting base rail of the invention to the rear-most portion of the vehicle frame rails can also be employed (and thus not illustrated) for mounting to other areas of the frame rails as well as mounting to the vehicle body.

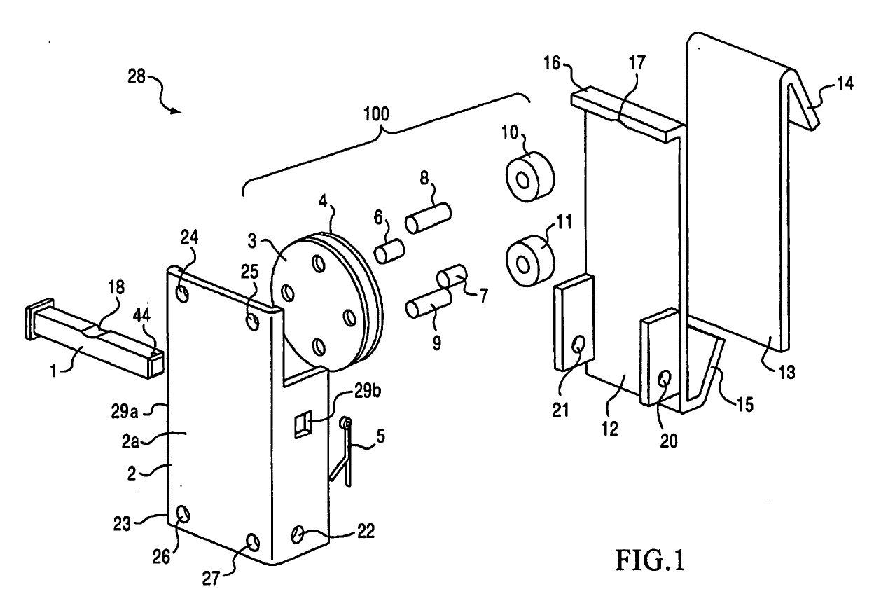

FIG. 1 is an exploded isometric view of the mounting clamp assembly 28 serving as the accessory adapter of the present invention. Upper jaw cover 2 is welded to upper jaw 13. A cam assembly 100 is created by assembling disks 3 and 4, first inserting and fastening pins 6 and 7 in matching open, 180 degree opposed holes in the disks, the length of the pins equal to the combined thickness of the two disks plus the thickness of the cam-rotation bar 33 plus a tolerance to allow for the easy insertion and removal of the bar, with the outer, opposed faces of disks 3 and 4 flush with the opposing ends of pins 6 and 7. Pins 8 and 9 are then inserted and fastened in the remaining open holes of disks 3 and 4, with one end of each pin flush with the outer edge of disk 3 and the pins being equal in length to pins 6 and 7 plus the thickness of cam rollers 10 and 11, respectively. Cam rollers 10 and 11 are then slipped over the protruding ends of pins 8 and 9, thereby completing the cam assembly 100.

Lower jaw 12 is inserted into the space between upper jaw 13 and upper jaw cover 2, with the V-shaped portion 15 of the lower jaw 12 oriented the same as that of the V-shaped portion 14 of the upper jaw 13 with the nearest surfaces of both jaws 12, 13 in contact with each other. Once the lower jaw 12 is slid fully up into the upper jaw 13 and cover assembly, the cam assembly 100 is slid up into the space that exists between the lower jaw 12 and the upper jaw cover 2, with the cam roller side of the cam assembly 100 against the back of the lower jaw 12. With the cam assembly 100 rotated so that the cam rollers 10, 11 are side by side, and with both the lower jaw 12 and the cam assembly 100 inserted as far as possible into the upper jaw 13 and cover assembly, push-block 1 is inserted through holes 29a and 29b, with cam-locking notch 18 oriented towards the cam assembly 100. Cotter pin 5 is then inserted through hole 44, locking the push-block 1 in place.

Cam-locking notch 17 on the raised lip of the lower jaw 16 works in conjunction with the cam-locking notch 18 on push-block 1 to lock the cam assembly 100 at top dead center, the point at which the cam rollers 10, 11 are one above the other and the point at which the mounting clamp assembly 28 would be fully engaged with the mounting rail 30. At top dead center, holes 20, 21, 22, and 23 align, allowing a padlock, pin, or bolt (not shown) to be inserted through hole pairings 20 and 22 or 21 and 23 (or both, for that matter) as both a means of theft deterrence and prevention of accidental release of the mounting clamp.

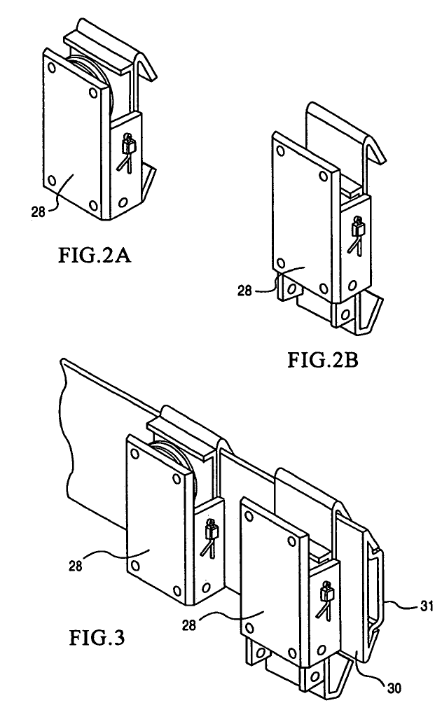

FIGS. 2A and 2B are isometric views of the mounting clamp assembly 28 in the closed and open positions, respectively. FIG. 2A shows mounting clamp assembly 28 with the lower jaw 12 in the raised, engaged position. FIG. 2B shows mounting clamp assembly 28 with the lower jaw 12 in the lowered, disengaged position.

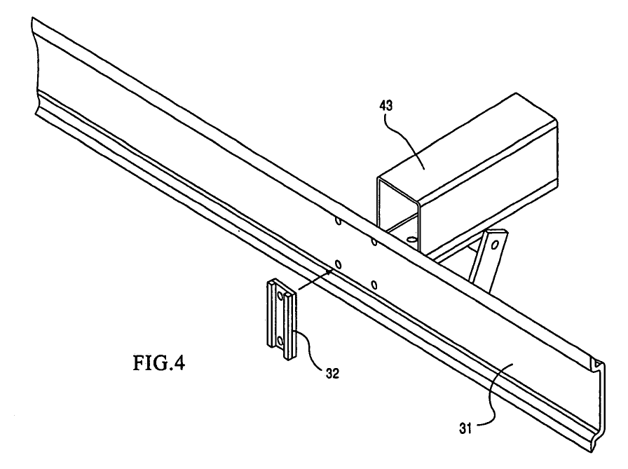

FIG. 3 is an isometric view of the mounting clamp assembly 28 of the present invention mounted on the mounting rail 30 of the present invention. This view is similar to those shown in FIGS. 2A and 2B except that it shows two mounting clamp assemblies 28, one closed and one open, on mounting rail 30, which is itself mounted to mounting rail base plate 31.

FIG. 4 is an isometric view of a rear mounted mounting rail base plate 31 with two-hole flange expander 32 adjacent to vehicle frame rail 43.

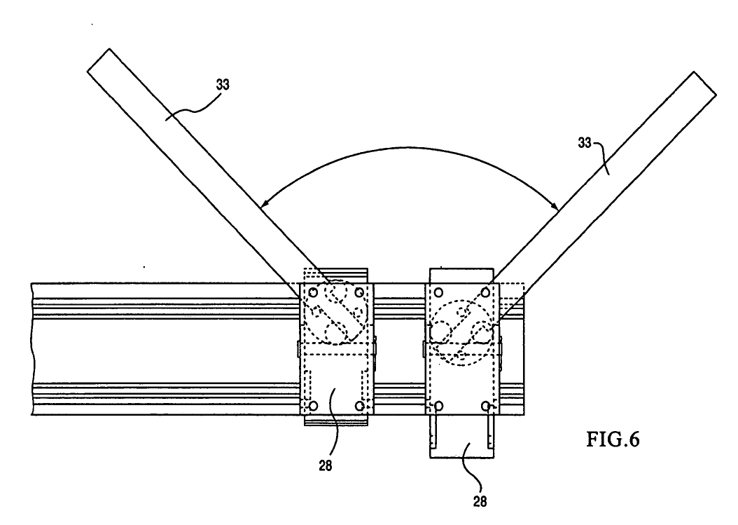

FIGS. 5A and 5B are frontal phantom views of mounting clamp assemblies 28 in the closed (engaged) and open (disengaged) positions, respectively. Mounting clamp assembly 28 in FIG. 5A shows that at top dead center—with cam rollers 10 and 11 one above the other—holes 20, 21, 22, and 23 align, allowing a padlock, pin, or bolt (not shown) to be inserted through hole pairings 20 and 22 or 21 and 23 (or both, for that matter) as both a means of theft deterrence and prevention of accidental disengagement of the mounting clamp.

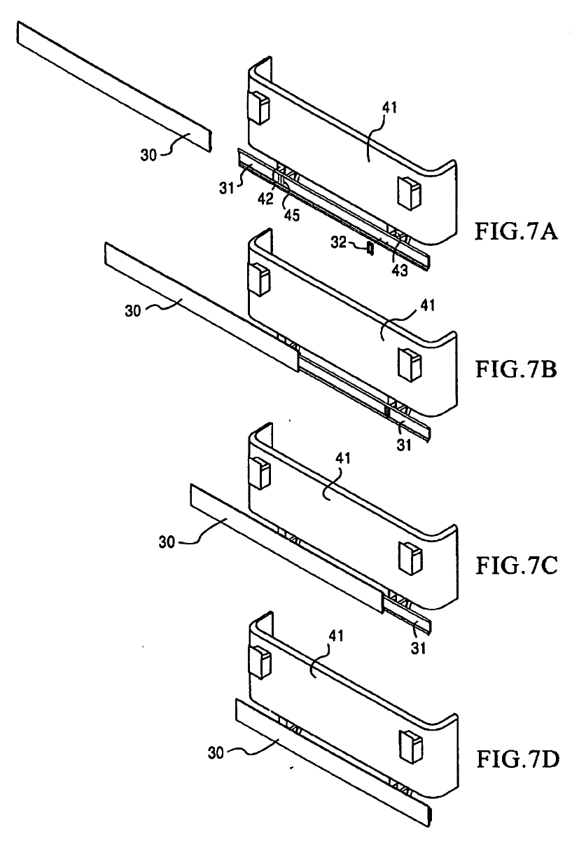

FIG. 6 is same view as FIGS. 5A and 5B but with removable cam-rotation bar 33 inserted. Bar 33 is inserted into the slot formed by disks 3 and 4 (FIG. 1) and pins 6, 7, 8, and 9 (FIG. 1). Bar 33 is shown at opposite ends of the 90 degree of travel required to engage or disengage the clamping mechanism.

FIGS. 7A-7D are isometric views showing four steps of a mounting rail assembly process. Mounting rail base plate 31 is loosely bolted to the vehicle using flange expander plates 32 and 45, as shown in FIG. 7A. The mounting rail cover 30 is then slid over the mounting rail base plate until flush at each end, as shown in FIGS. 7B-7D. At this point, the bolts (not shown) are tightened, drawing the flange expanders 32 and 45 to nest into the mounting rail base plate 31, expanding the mounting rail base plate 31 into the mounting rail cover 30, locking the cover in place.

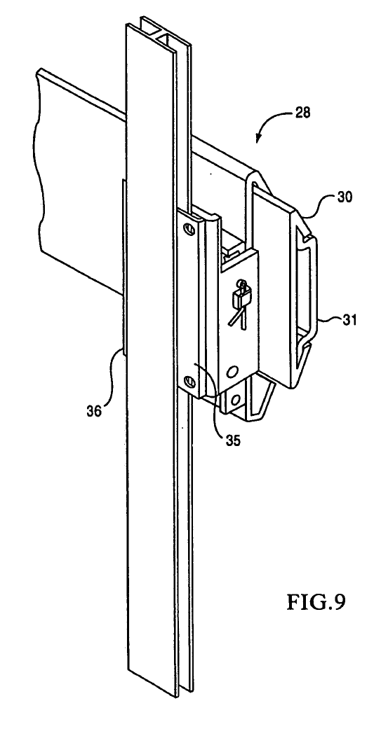

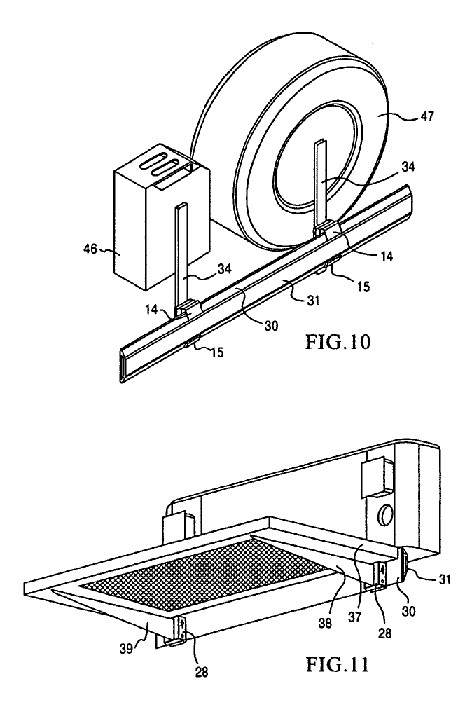

FIGS. 8 and 9 are isometric views of the slider rail 34 in use with the mounting clamp assembly 28 engaged on mounting rail cover 30. Gripping plates 35 and 36 clamp slider rail 34 to mounting clamp 28.

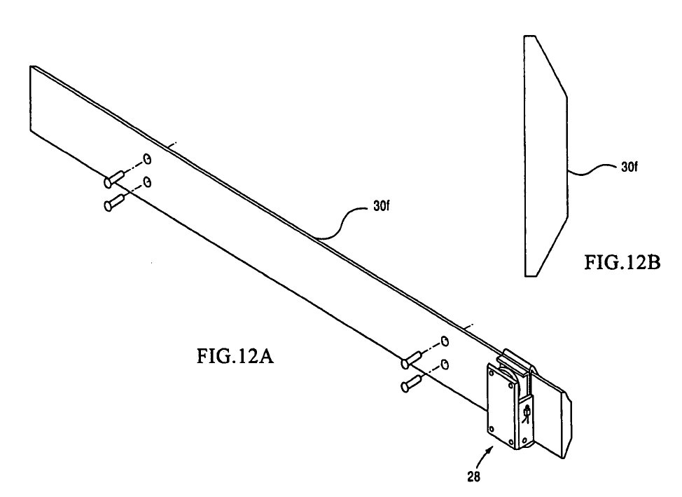

FIG. 10 is a reverse-angle isometric view showing concurrent mounting of two different accessories. Gas can 46 and spare tire 47 are each fastened to slider rails 34, 34, respectively. Upper and lower V-shaped jaws, 14 and 15, respectively, are also visible from this view.

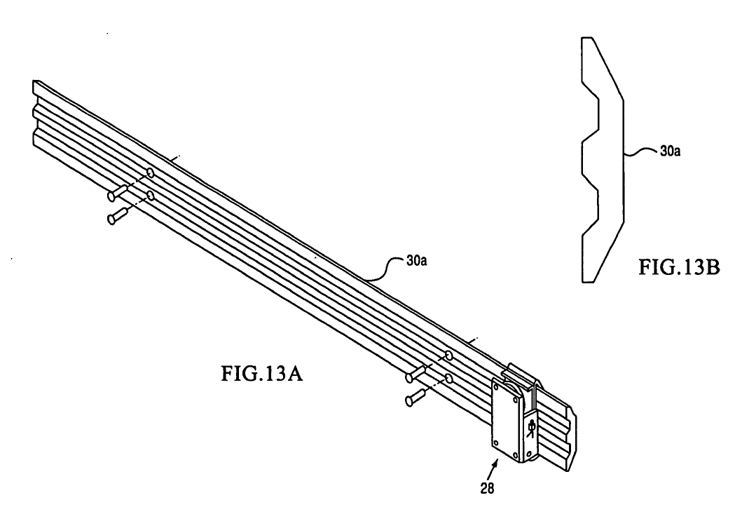

FIG. 11 is a low-angle isometric view in use with a single, large accessory, in this case cargo tray 37. Cargo tray 37 is fastened atop support rails 38 and 39, which are in turn fastened directly to mounting clamp assemblies 28, 28 which are themselves engaged on mounting rail cover 30, which is covering mounting rail base plate 31.

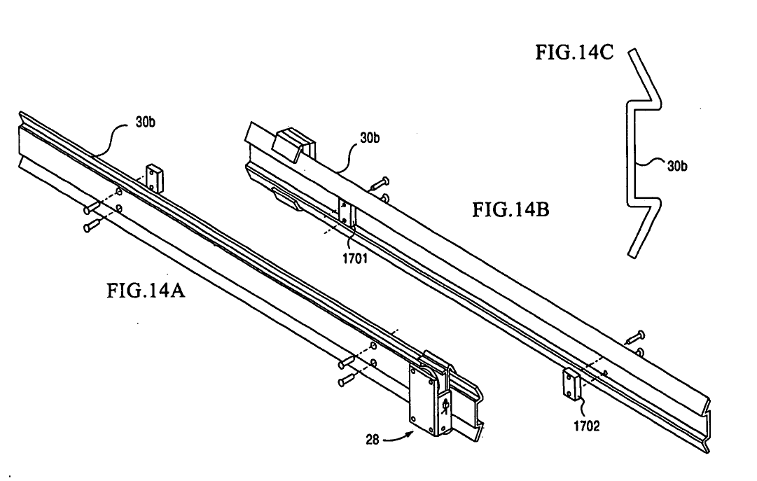

FIG. 12A is an isometric view of a solid mounting rail 30f with mounting clamp assembly 28 attached thereto. FIG. 12B is an end-on, profile view of this same solid mounting rail 30f. A solid mounting rail 30f offers advantages in strength, grip (coefficient of friction between the mounting clamp assembly 28 and said mounting rail 30f), and cost of manufacturing, but has disadvantages in weight and cost of shipping.

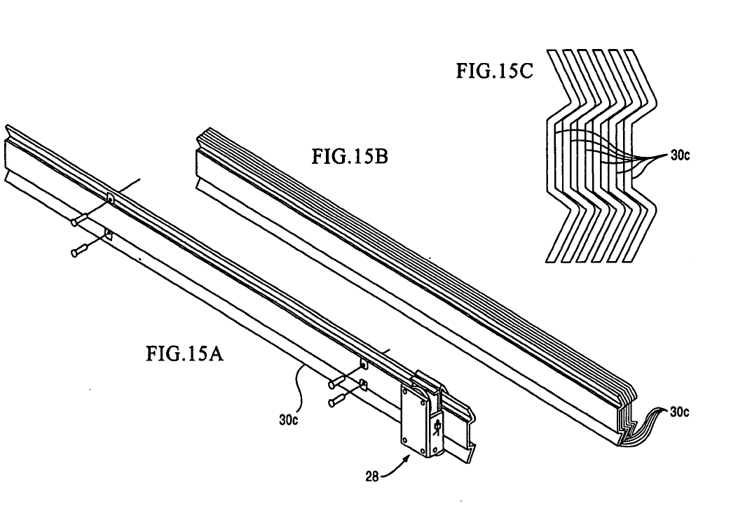

FIG. 13A is an isometric view of an “ornamental” solid mounting rail 30a with mounting clamp assembly 28 attached thereto. FIG. 13B is an end-on, profile view of this same mounting rail 30a. This type of mounting rail offers advantages over the standard solid mounting rail 30f in weight and cost of shipping, but provides less grip due to the reduced surface area of the mounting rail face as well as having a higher cost of manufacture.

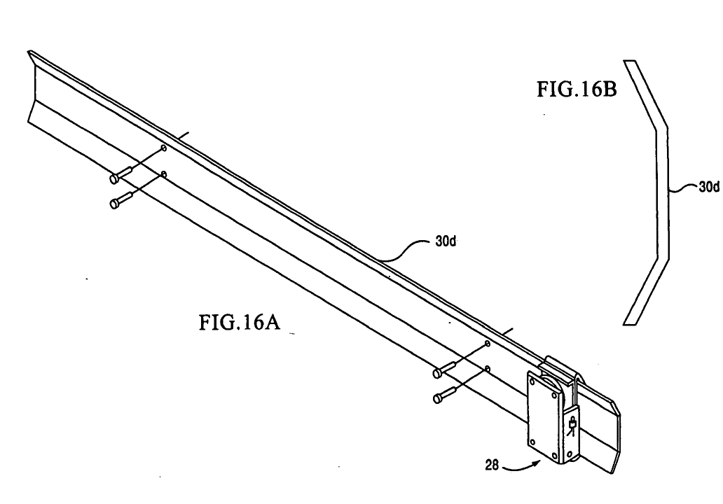

FIG. 14A is an isometric view of a “stamped” mounting rail 30b having a large center groove with mounting clamp assembly 28 attached thereto. FIG. 14B is a reverse view of this same mounting rail 30b, showing the use of optional spacer blocks 1701 and 1702. FIG. 14C is an end-on, profile view of this same mounting rail 30b without the spacer blocks 1701 and 1702. This type of mounting rail 30b offers advantages over the standard solid mounting rail 30f in weight, cost of manufacture, and cost of shipping, but provides less grip and strength.

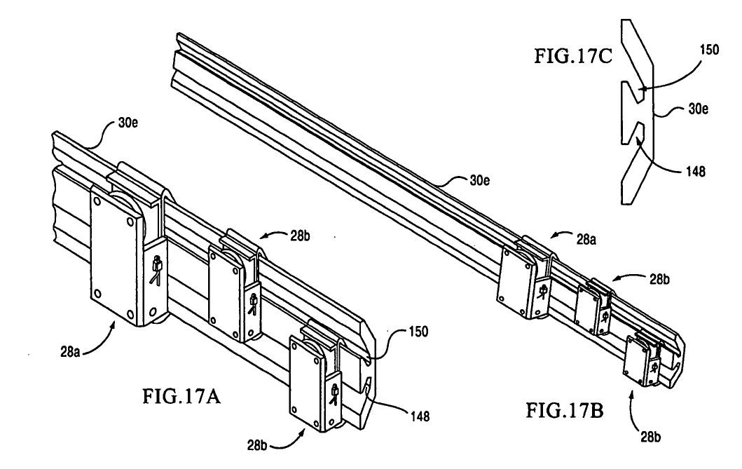

FIG. 15A is an isometric view of another “stamped” mounting rail 30c with mounting clamp assembly 28 attached thereto, this one designed to nest one within another for reduced shipping costs. FIG. 15B is an isometric view of this same mounting rail 30c, nested with five others of similar type. FIG. 15C is an end-on, profile view of six of these type of mounting rails 30c nested together for shipment. This type of mounting rail offers advantages over the stamped mounting rail 30b shown in FIGS. 14A-14C, primarily in cost of shipping due to the greater number of rails that will fit in a given space, but provides slightly less grip. Strength, weight, and cost of manufacturing are comparable to the stamped mounting rail 30b in FIGS. 14A-14C.

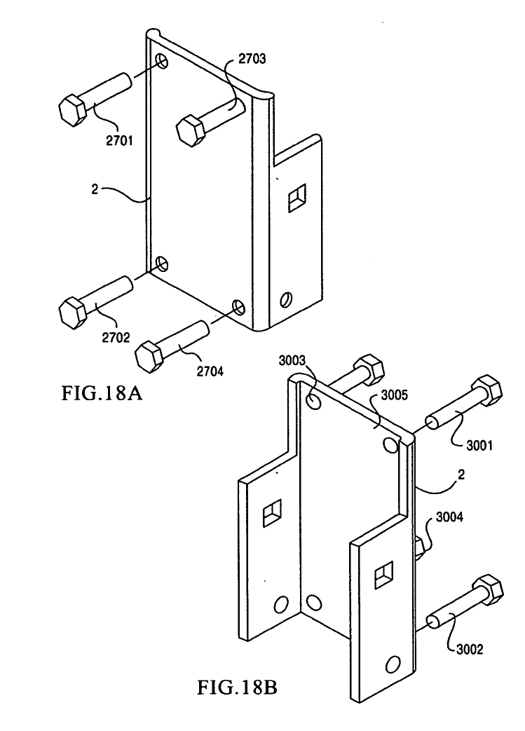

FIG. 16A is an isometric view of another “stamped” mounting rail 30d with mounting clamp assembly 28 attached thereto, this one being possibly the simplest construction. FIG. 16B is an end-on, profile view of this same mounting rail 30d. This type of mounting rail 30d offers advantages over the stamped mounting rails 30b, 30c shown in FIGS. 14A-14C and in FIGS. 15A-15C primarily in weight, cost of shipping, and cost of manufacture, but provides significantly less grip and strength.

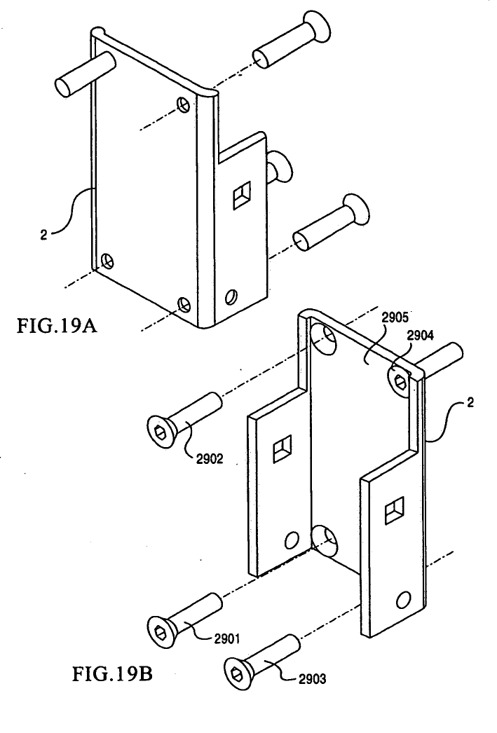

FIGS. 17A-17C are isometric views of an “extruded” solid mounting rail 30e with mounting clamps 28a, 28b attached, FIG. 17A being a close up of FIG. 17B. FIG. 17C is an end-on, profile view of this same mounting rail 30e. One advantage of this type of mounting rail 30e is its ability to accommodate different sized mounting clamp assemblies 28a, 28b. This allows the user to attach “light-duty” accessories to a “heavy-duty” mounting rail 30e. Full-sized mounting clamp assembly 28a clamps over the entire rail 30e, while small mounting clamp 28b assembly clamps over the upper edge of the mounting rail 30e and a lower groove 148 in the face of the mounting rail 30e, while small mounting clamp assembly 28b clamps over an upper groove 150 in the face of the mounting rail 30e and the lower edge of the mounting rail 30e.

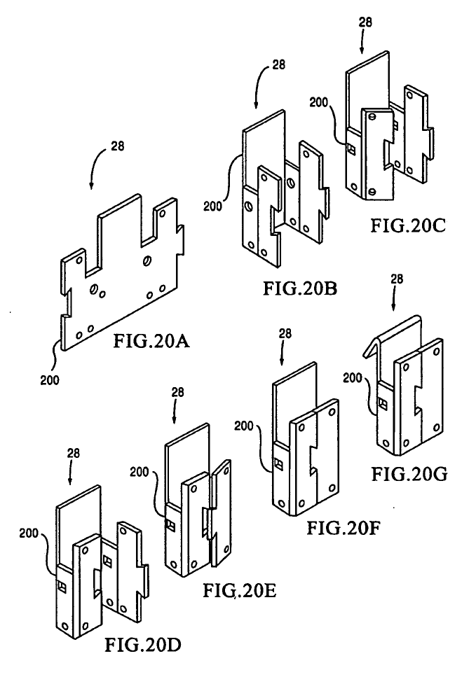

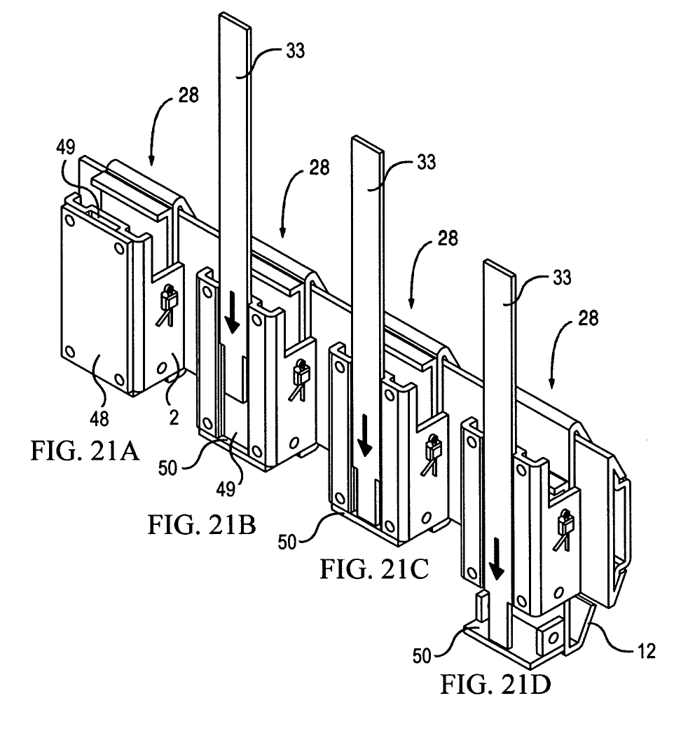

FIGS. 18A-18B and 19A-19B are isometric views of the upper mounting clamp cover 2 showing two different methods of fastening accessories/slider rails to the upper mounting clamp cover 2. FIGS. 18A and 18B show front and back views whereby standard bolts 2701-2704 are screwed into threaded holes in the upper mounting clamp cover 2. Bolt 3003 shows how the bolt tip must not protrude past being flush with the inner face 3005 of the upper mounting clamp cover 2 so as not to inhibit the sliding of the cam action. The advantage to using this method is that any length bolt may be used, so long as the end of the bolt does not protrude past flush with the inner face of the mounting clamp cover. FIGS. 19A and 19B show front and back views whereby bolts 2901-2904 with countersunk heads and flat tops are inserted from the inside out through smooth bore, countersunk holes. Bolt 2904 shows how the bolt head must not protrude past being flush with the inner face 2905 of the upper mounting clamp cover 2 so as not to inhibit the sliding of the cam action. The advantage to using this method is that the risk of damaged threads rendering a bolt hole unusable is eliminated, as well as it providing a stronger attachment of the accessory/slider rail 34.

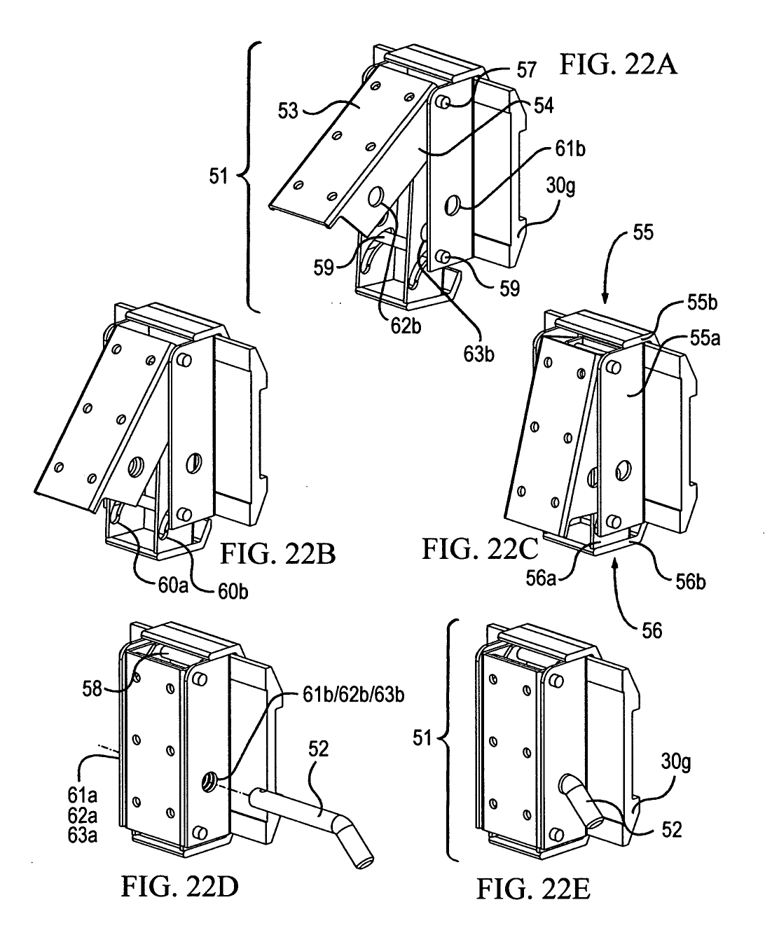

FIGS. 20A-20G show one method of constructing the mounting clamp assembly 28. In this method, a single piece of stamped material 200 is folded to create the assembly, with one or more keyed tabs and slots interlocking on the accessory mounting face. An optional weld may be applied along this seam. FIG. 20G shows the final step of bending the jaw portion of the mounting clamp assembly 28 into place.

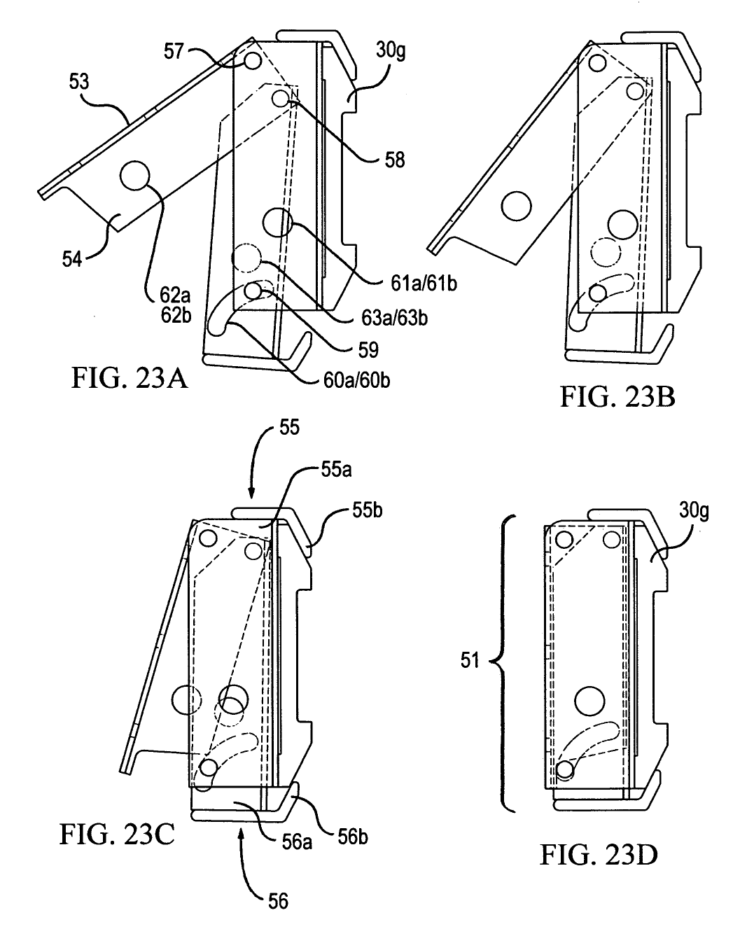

FIGS. 21A-21 D show cam-rotation bar stowage and lower jaw release method. Cam-rotation bar stowage channel 50 can be integrated into clamp cover 2 through the formation of channel 49 in the accessory mounting face of mounting clamp 28. With accessory mounting plate 48 bolted to mounting clamp 28, channel 49 provides a slot into which cam-rotation bar 33 can be inserted for stowage. FIGS. 21B-21D show channel 49 with accessory mounting plate 48 removed. Cam-rotation bar stowage slot 49 used in combination with striking surface 50 attached to the lower jaw 12, allows the downward force of cam-rotation bar 33 to jar lower jaw 12 loose. With lower jaw 12 in its lowest-most position, striking surface 50 then serves as a stop to prevent cam-rotation bar 33 from sliding out of the bottom of stowage channel 49, providing secure stowage for cam-rotation bar 33.

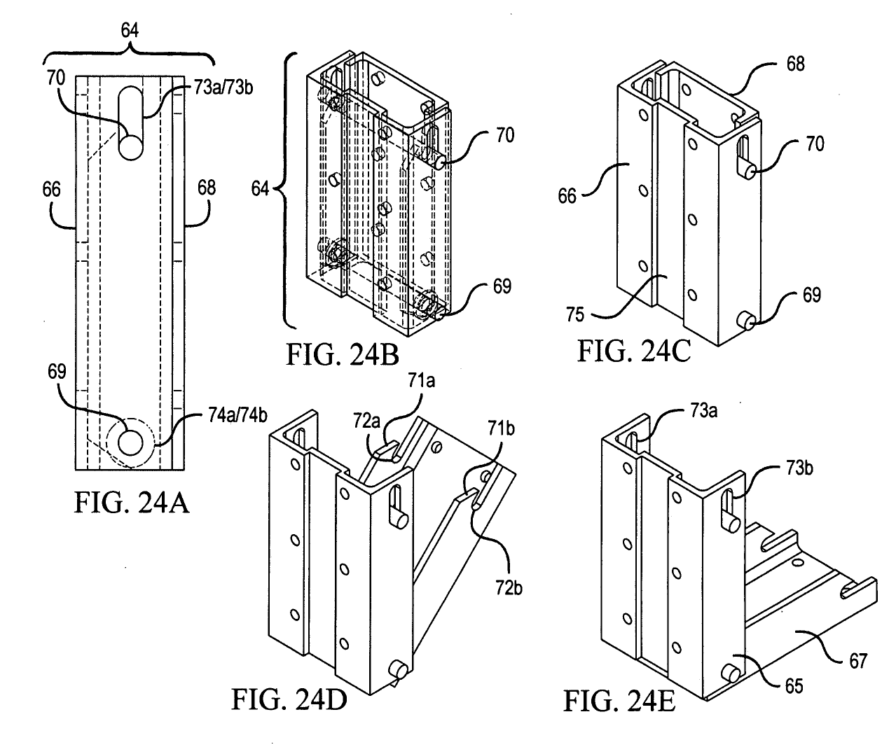

FIGS. 22A-22E are isometric views of the second embodiment of a mounting clamp transitioning from fully open to fully closed and locked. FIG. 22A shows clamp assembly 51 in the fully open position and positioned on mounting rail 30g in preparation for closing. An accessory (not shown) would be attached to accessory mounting face 53 and act as a lever arm to rotate clamp actuator 54 around clamp actuator pivot pin 57. As the bottom of clamp actuator 54 pivots inward (toward lower jaw guide pin 59), lower jaw pivot pin 58 draws lower jaw assembly 56, comprised of lower jaw body 56a and lower jaw v-shaped interface 56b, upward while lower jaw guide slots 60a and 60b guide the bottom of lower jaw assembly 56 inward and upward, engaging bottom of mounting rail 30g with lower jaw v-shaped interface 56b. As clamp actuator 54 completes its rotation into a closed state as shown in FIG. 22D, it draws the upper jaw assembly 55, comprised of upper jaw body 55a and upper jaw v-shaped interface 55b, and lower jaw assembly 56 together, creating the interference-fit clamping-force necessary to hold clamp assembly 51 in place on mounting rail 30g. With clamp actuator 54 in its fully closed position, retention pin 52 is inserted through the now aligned upper jaw retention holes 61a and 61b, clamp actuator retention holes 62a and 62b, and lower jaw retention holes 63a and 63b. FIG. 22E shows clamp assembly 51 closed and locked onto mounting rail 30g with retention pin 52 securing clamp assembly 51 in closed state.

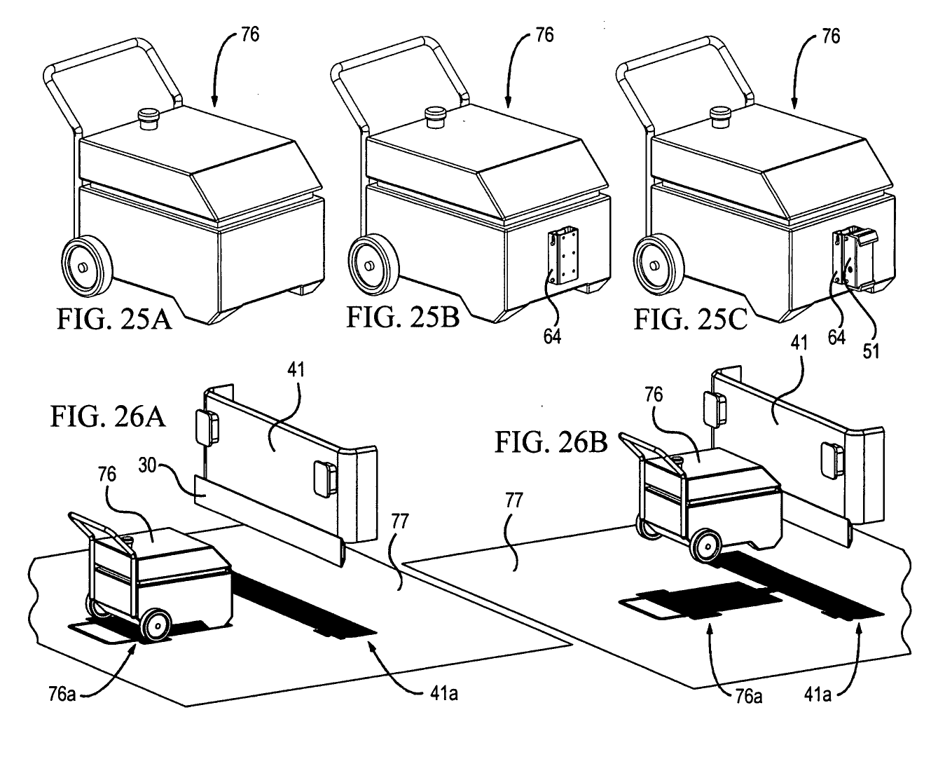

FIGS. 23A-23D are side phantom views of the second embodiment of a mounting clamp transitioning from fully open to fully closed and match FIGS. 22A-22D respectively.

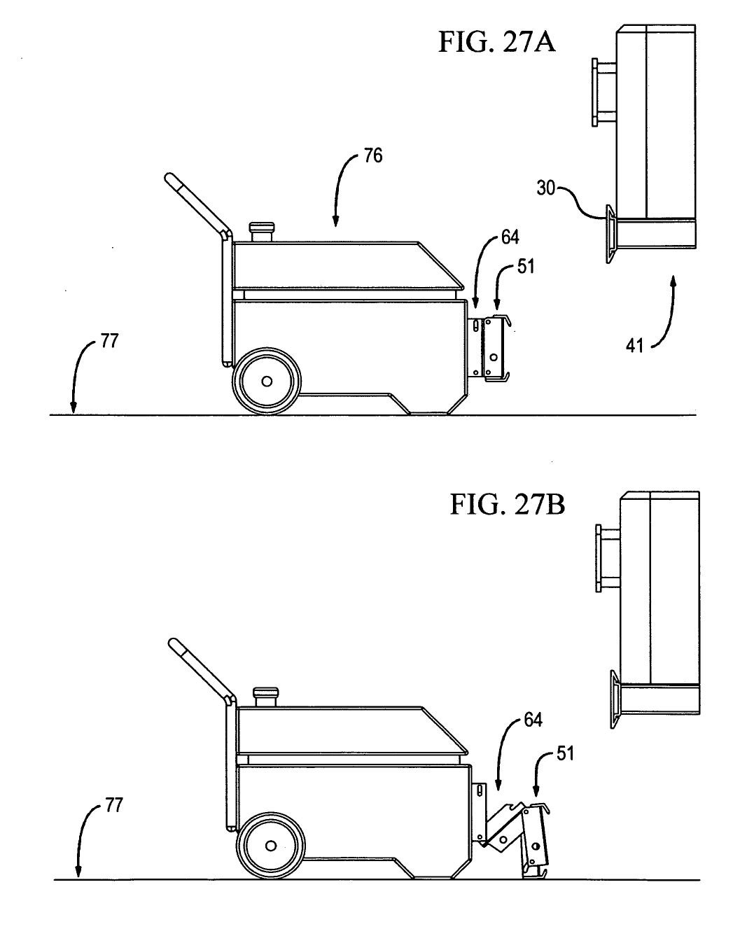

FIG. 24A is a side phantom view of hinged latching mechanism assembly 64. Clamp mounting face 68 attaches to either first clamp embodiment accessory mounting face 2a from FIG. 1 or second clamp embodiment accessory mounting face 53 from FIG. 22A. Hinged latching mechanism accessory mounting face 66 attaches to the accessory in place of the clamp accessory mounting faces 2a and 53, sandwiching hinged latching mechanism assembly 64 between the accessory and the clamp.

FIGS. 24B-24E are isometric views of hinged latching mechanism assembly 64 in various states. FIG. 24B is a phantom view of hinged latching mechanism assembly 64 in a closed state, while FIG. 24C is the same state but in a solid view. FIG. 24D shows hinged latching mechanism assembly 64 half open and FIG. 24E shows hinged latching mechanism assembly 64 fully open. When closing hinged latching mechanism assembly 64, internal mounting body 67 rotates about assembly pivot pin 69, bringing latch strike plates 71a and 71b in contact with assembly latch pin 70, lifting said pin to the top of latch guide slots 73a and 73b until latch strike plates 71a and 71b can pass beneath unhindered. Once internal mounting body 67 completes its rotation into a closed state in relationship to external mounting body 65, latch pin 70 is free to drop down in latch guide slots 73a and 73b and into the now aligned latch retention notches 72a and 72b, securing internal mounting body 67 to external mounting body 65 in a closed state.

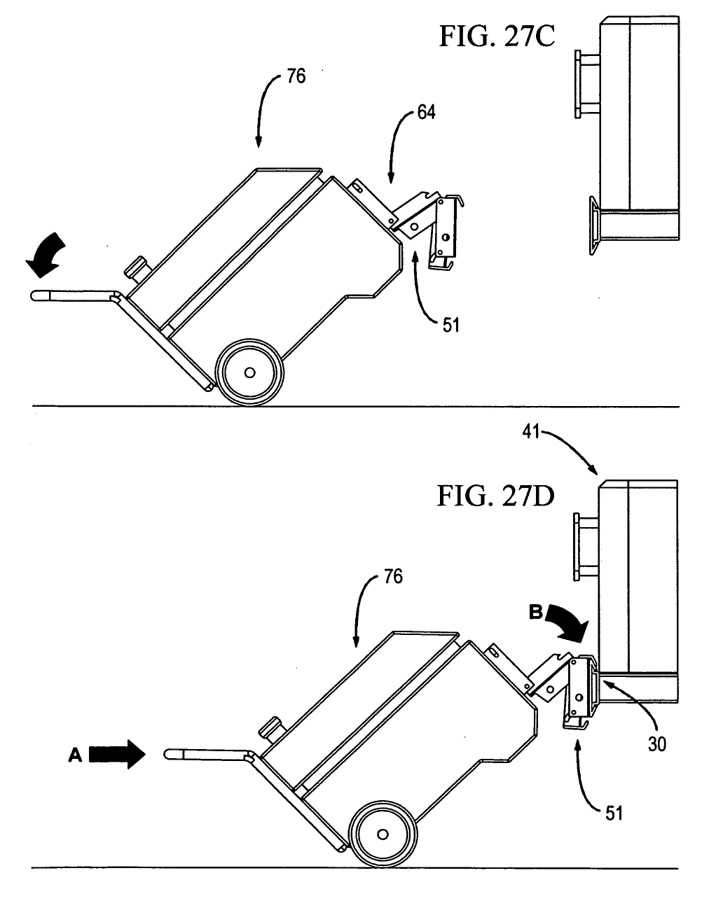

FIGS. 25A-25C are isometric views of a wheeled accessory being outfitted with a hinged latching device and mounting clamp. In FIG. 25A, portable generator 76 is shown sans any invention components. In FIG. 25B, portable generator 76 is shown with hinged latching mechanism assembly 64 permanently and directly attached. FIG. 25C then shows second clamp embodiment assembly 51 permanently and directly attached to hinged latching mechanism assembly 64, which is itself permanently and directly attached to portable generator 76. In this configuration, portable generator 76 is equipped to be mounted to a mounting rail equipped vehicle.

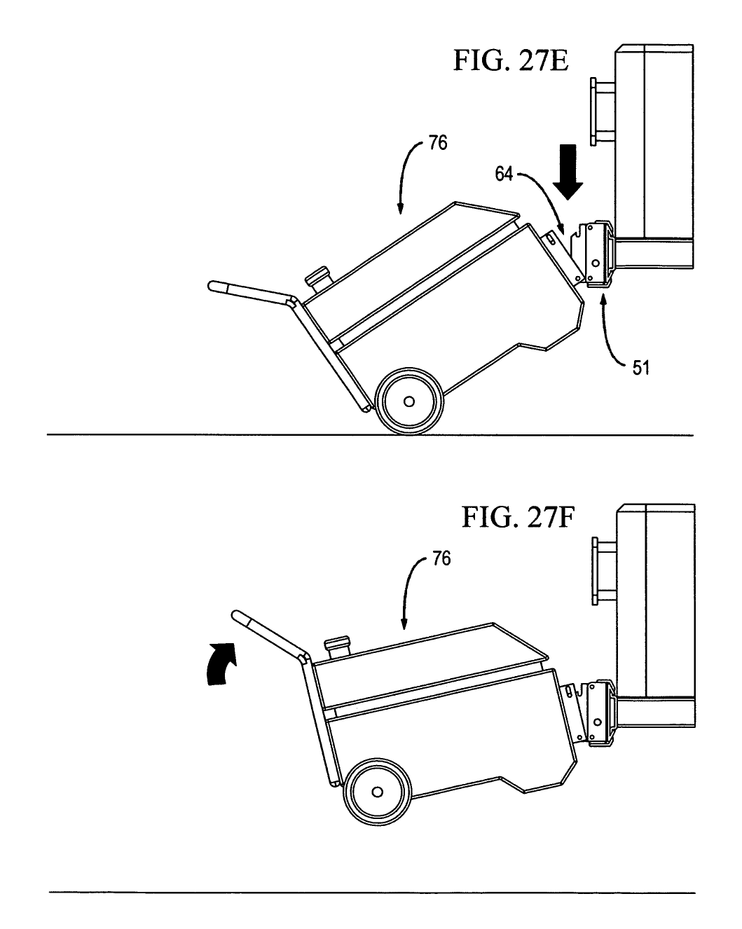

FIGS. 26A and 26B are isometric views showing portable generator 76 before and after mounting to sport utility type of vehicle 41. Portable generator shadow 76a and sport utility type of vehicle shadow 41a provide a gauge of height change for portable generator 76 after mounting to sport utility type of vehicle 41. FIG. 26A shows portable generator 76 resting on ground 77 with mounting rail 30 completely visible. FIG. 26B shows portable generator 76 suspended above ground 77 due to mounting onto sport utility type of vehicle 41.

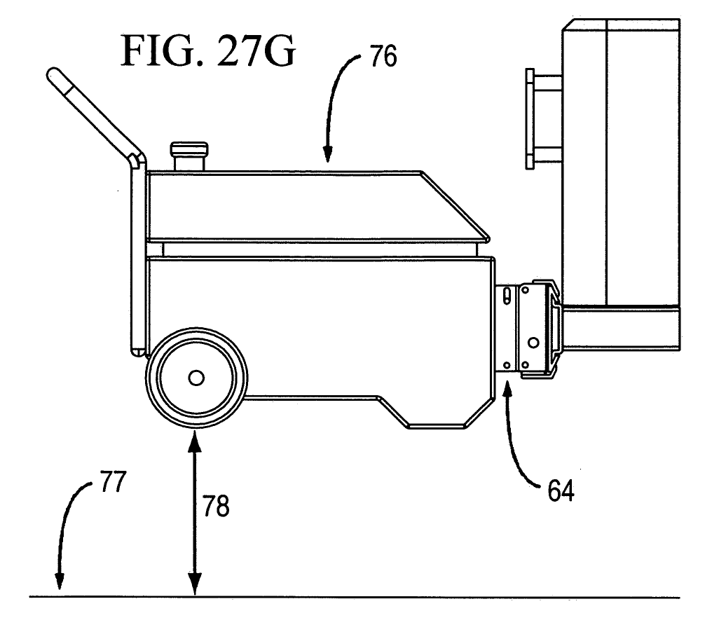

FIGS. 27A-27G are solid side views of the steps needed to mount a wheeled accessory equipped with a mounting clamp and a hinged latching mechanism to a mounting rail equipped sport utility type of vehicle. FIG. 27A shows portable generator 76 resting on ground 77 with hinged latching mechanism assembly 64 and second clamp embodiment assembly 51 permanently attached and both in closed state, positioned to begin procedure to mount portable generator 76 to mounting rail 30 on sport utility type of vehicle 41. FIG. 27B shows both second clamp embodiment assembly 51 and hinged latching mechanism assembly 64 in a semi-open state resting atop ground 77. FIG. 27C shows portable generator 76 rotated back, allowing second clamp embodiment assembly 51 and hinged latching mechanism assembly 64 to relax into fully open states. FIG. 27D shows the movement (A) of portable generator 76 toward sport utility type of vehicle 41 followed by forward rotation (B) to engage second clamp embodiment assembly 51 onto mounting rail 30. FIG. 27E shows the relaxed state of hinged latching mechanism assembly 64 and second clamp embodiment assembly 51. This relaxed state forces second clamp embodiment assembly 51 into a closed state, at which point retention pin 52 (not shown) can be inserted to lock second clamp embodiment assembly 51. FIG. 27F shows portable generator 76 being rotated upward toward fully mounted position. FIG. 27G shows portable generator 76 in its fully mounted position. Hinged latching mechanic assembly 64 is now in a fully closed and latched state, supporting portable generator 76 above ground 77 creating clearance gap 78.

What is claimed:

1. An accessory mounting system for a vehicle comprising:
at least one horizontally-oriented mounting rail attached to at least an end or a side of the vehicle, said mounting rail having a trapezoidal cross-sectional shape with the wider of two parallel faces facing outward from the vehicle;
at least one mounting clamp assembly detachably connected to said mounting rail for mounting an accessory to said vehicle; and
a mounting clamp assembly clamping and releasing means contained within said mounting clamp assembly for clamping and releasing said mounting clamp assembly from said mounting rail.

2. The accessory mounting system as recited in claim 1, wherein said mounting clamp assembly comprises a pair of opposed V-shaped jaws each having an equal or slightly more acute angle than that represented by the angle between the wider of two parallel faces of the mounting rail and one of two adjoining non-parallel faces of the mounting rail such that when the mounting clamp assembly is engaged on the mounting rail, the mounting rail is arranged between said pair of opposing jaws of the mounting clamp assembly.

3. The accessory mounting system as recited in claim 2, wherein said mounting clamp assembly clamping and releasing means causes said pair of V-shaped jaws to move toward or away from one another to provide a clamping and releasing action, respectively, upon said mounting rail.

4. The accessory mounting system as recited in claim 3, wherein said mounting clamp assembly clamping and releasing means comprises a cam assembly for moving said pair of V-shaped jaws toward or away from one another.

5. The accessory mounting system as recited in claim 1, wherein said mounting rail comprises:
a mounting rail base plate permanently attached to a frame of said vehicle; and
a mounting rail cover slidably covering said mounting rail base plate.

6. The accessory mounting system as recited in claim 1, further comprising at least one vertically-oriented rail, wherein said mounting clamp assembly further comprises at least one pair of gripping plates for gripping said slider rail.

7. The accessory mounting system as recited in claim 1, further comprising a pair of said mounting clamp assemblies and a pair of corresponding horizontally-oriented support rails attached thereto.

8. The accessory mounting system as recited in claim 1, wherein said mounting rail is a solid, single piece.

9. The accessory mounting system as recited in claim 1, wherein said mounting rail is a solid, single stamped piece.

10. The accessory mounting system as recited in claim 9, wherein said mounting rail is stamped to have a shape which permits nesting of a plurality of said mounting rails one within another.

11. The accessory mounting system as recited in claim 1, wherein said mounting rail is a solid, single extruded piece having at least one horizontal groove arranged on a side facing said mounting clamp assembly.

12. The accessory mounting system as recited in claim 1, wherein said mounting rail is a solid, single extruded piece having at least one horizontal groove arranged on a side facing said mounting clamp assembly, and further comprising:
at least one large mounting clamp assembly and at least one small mounting clamp assembly,
wherein said large mounting clamp assembly comprises a pair of opposed V-shaped jaws each having an equal or slightly more acute angle than that represented by the angle between the wider of two parallel faces of the mounting rail and one of two adjoining non-parallel faces of the mounting rail such that when the large mounting clamp assembly is engaged on the mounting rail, the mounting rail is arranged between said pair of opposing jaws of the large mounting clamp assembly, and
wherein said small mounting clamp assembly comprises a pair of opposed V-shaped jaws each having the same angle as the pair of opposed jaws of the large mounting clamp assembly, one of the jaws of the small mounting clamp assembly adapted to be engaged on an edge of the mounting rail and the other one of the jaws of the small mounting clamp assembly adapted to be engaged on a lip of one of said horizontal grooves.

13. An accessory mounting system comprising:
at least one horizontally-oriented mounting rail attached to a larger structure, said mounting rail having a trapezoidal cross-sectional shape with the wider of two parallel faces facing outward from the structure;
at least one mounting clamp assembly detachably connected to said mounting rail for mounting an accessory to said structure; and
a mounting clamp assembly clamping and releasing means contained within said mounting clamp assembly for clamping and releasing said mounting clamp assembly from said mounting rail.

14. The accessory mounting system as recited in claim 3, wherein said mounting clamp assembly clamping and releasing means comprises a hinged latching mechanism.

15. The accessory mounting system as recited in claim 14, wherein said hinged latching mechanism comprises a clamp actuator having an accessory mounting face, said clamp actuator being pivotally connected to each of said V-shaped jaws at different positions such that as said clamp actuator is pivoted away from said V-shaped jaws, said V-shaped jaws increase their spacing from each other and as said clamp actuator is pivoted toward said V-shaped jaws, said V-shaped jaws decrease their spacing from each other.

16. The accessory mounting system as recited in claim 15, further comprising a retention pin for inserting through holes in said clamp actuator and said pair of V-shaped jaws which are aligned only when said clamp actuator is fully closed.

17. The accessory mounting system as recited in claim 4, further comprising a cam-rotation bar to be inserted in said cam assembly for moving said pair of V-shaped jaws toward or away from each other.

18. The accessory mounting system as recited in claim 17, wherein said mounting clamp assembly includes an accessory mounting face fixed to a clamp cover with a channel formed therebetween for storing said cam-rotation bar.

19. The accessory mounting system as recited in claim 2, said mounting clamp assembly further comprising:
a jaw cover, having an accessory mounting face, fixed to one of said V-shaped jaws; and
a hinged latching mechanism assembly which is fixable to said accessory mounting face and an accessory to be mounted to said mounting clamp assembly, said hinged latching mechanism adapted to permit the accessory to be pivotally moved relative to said mounting clamp assembly.

20. The accessory mounting system as recited in claim 18, further comprising a hinged latching mechanism assembly which is fixable to said accessory mounting face as an accessory to be mounted to said mounting clamp assembly, said hinged latching medium assembly adapted to permit the accessory to be pivotally moved relative to said mounting clamp assembly.
